(19) United States
(12) Patent Application Publication
(10) Pub. No.: US 2011/0048854 A1
(43) Pub. Date: Mar. 3, 2011

(54) PROTECTIVE COVER FOR LADDER ENDS

(76) Inventors: Clifford Sebring, Gilrov, CA (US); Calvin C. Sebring, Gilrov, CA (US); Sylvia T. Sebring, Gilrov, CA (US)

(21) Appl. No.: 12/862,667

(22) Filed: Aug. 24, 2010

Related U.S. Application Data
(60) Provisional application No. 61/236,826, filed on Aug. 25, 2009.

(51) Int. Cl. E06C 7/42; E06C 7/46

(52) U.S. Cl. 182/108

(57) ABSTRACT

The present invention is directed toward a protective cover adapted for covering the end of a ladder leg in order to prevent damage to buildings or other structures when the ladder is in use. In addition, a cover with non-skid properties is disclosed, such that the device can be used to prevent a ladder from slipping against the ground or a structure and causing injury to a user or property.

### CLAIM OF PRIORITY

The following application claims priority to U.S. Provisional Patent Application No. 61/236,826, filed Aug. 25, 2009, the complete contents of which are hereby incorporated by reference.

### BACKGROUND

1. Field of the Invention

The present invention relates to the field of building and home improvement supplies, specifically a protective cover for the end of a ladder.

2. Background

Ladders are necessary elements for any commercial or residential construction project, or even for simple, everyday home improvement tasks. Among other things, ladders can be used for reaching high places while painting a house, for making repairs to a commercial office building, or for washing windows. However, the ends of a ladder can present safety issues and can cause cosmetic damage to structures.

When leaning against a wall or building, the top ends of a ladder can scrape or press into the structure and cause damage. Not only can this be a problem when the ladder is not in use, but the weight and constant shifting of a user's body can exacerbate the damage to the structure. Moreover, the top and/or bottom ends of a ladder can slip against the ground or structure, depending on the condition of the ground or type of material on which the ladder leans. This presents a safety issue, especially when a user is several feet off the ground and engaged in building or improvement tasks.

What is needed is a cover that can be easily applied to an end of a ladder. The cover should have anti-skid coating or inherent anti-skid properties. In some embodiments, the cover should have extra padding to protect structures from damage caused by rough or pointed edges on a ladder end. The cover should have a mechanism for easy and temporary attachment to a ladder, such as a drawstring or elastic. The cover should also be easy to clean if made for several uses, or disposable intended for one-time use.

### BRIEF DESCRIPTION OF THE DRAWINGS

FIG. 1 depicts a front view of one embodiment of the present invention.

FIG. 1A depicts another embodiment of the present invention and illustrates the end of a ladder leg within the invention.

FIG. 1B depicts an alternate embodiment of the present invention.

FIG. 2A depicts one embodiment of the present invention with non-skid coating.

FIG. 2B depicts a pad coupled with the exterior surface of an embodiment of the present invention.

FIG. 2C depicts a pad embedded within the material of an alternate embodiment of the present invention.

FIG. 3 illustrates a ladder standing on a ground surface and coupled with the present invention.

FIG. 4 illustrates a ladder leaning against a building and coupled with the present invention.

FIG. 5 illustrates the present invention coupled with the leg ends of an “A” frame ladder.

### DETAILED DESCRIPTION

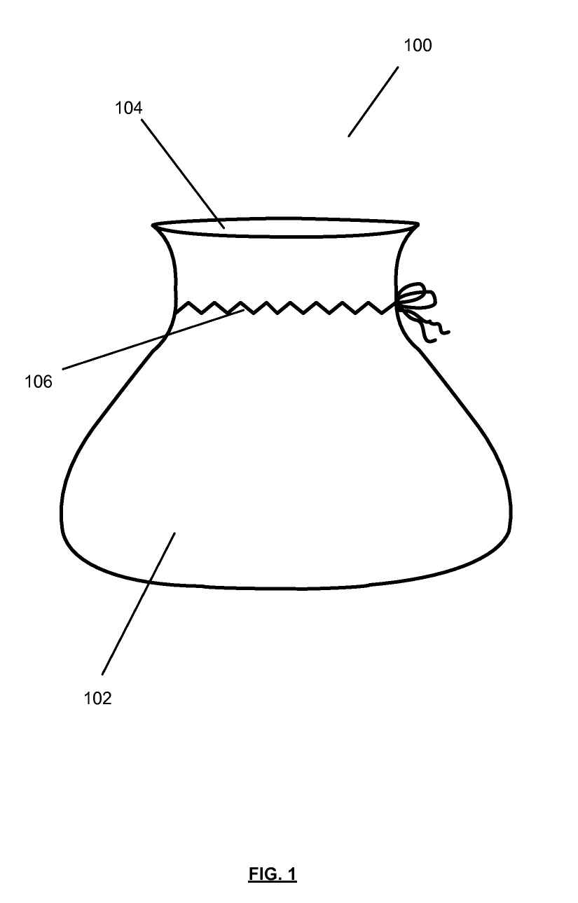

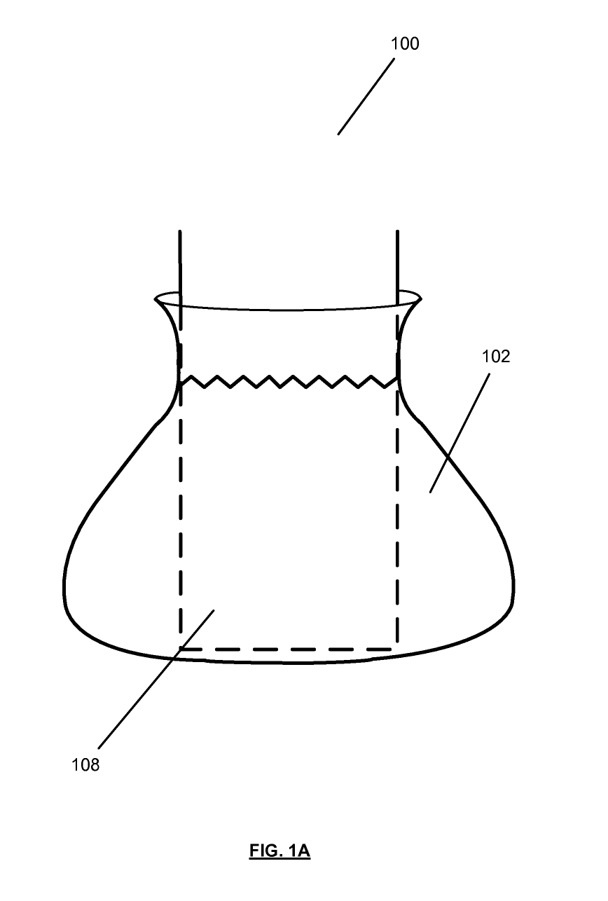

FIGS. 1-1A depict one embodiment of the present invention. A cover 100 can comprise a substantially hollow member 102 having at least one opening 104. An opening 104 can be adapted to receive at least a portion of the end of a ladder leg 108, as depicted in FIG. 1A. In some embodiments, a substantially hollow member 102 can further comprise an adjustment mechanism 106.

A substantially hollow member 102 can have a substantially bulbous geometry, as depicted in FIG. 1. In other embodiments, a substantially hollow member 102 can have any other known and/or convenient geometry. In some embodiments, a substantially hollow member 102 can be comprised of elastomeric material and/or can conform to the dimensions and/or geometry of a ladder leg end 108. In other embodiments, a substantially hollow member 102 can have dimensions larger than that of the end of a ladder leg 108, for ease of application to a ladder leg 108, and can be tightened around a ladder leg 108 via an adjustment mechanism 106, described below.

A substantially hollow member 102 can be constructed from plastic, silicone, nylon, cloth, polymer, and/or any other known and/or convenient material. In some embodiments, a substantially hollow member 102 can be comprised of fibers interwoven with strands of stainless steel for added strength. In other embodiments, a substantially hollow member 102 can be at least partially reinforced with adhesive or other coating and/or treatment that can increase the strength of the hollow member 102. A substantially hollow member 102 can be adapted to withstand the weight and/or sharp or pointed corners or edges of a ladder leg 108 without tearing or wearing down. In some embodiments, a substantially hollow member 102 can have reinforced seams, edges, and/or lining. In yet other embodiments, at least part of a cover 100 can be comprised of sterile, medical-grade, and/or hospital-grade materials such that a cover 100 can be used in a hospital and/or sterile environment.

A substantially hollow member 102 can comprise any known and/or convenient color or combination of colors. In some embodiments, a cover 100 can comprise one or more colors and/or symbols that can indicate that the cover 100 should be used with a specific type of ladder. As depicted in FIG. 1B, in some embodiments a cover 100 can further comprise a pocket or pouch 110 that can be adapted to accept a substantially hollow member 102 such that a cover 100 can be stored in the pocket or pouch 110 when not in use. In other embodiments, a pocket or pouch 110 can be adapted to temporarily store nails, screws, nuts, bolts, tools, paint brushes, and/or any other known and/or convenient item. In further embodiments, a cover 100 can comprise at least one hook, ring, loop, and/or any other type of mechanism for temporarily coupling multiple covers 100 with each other and/or coupling a cover 100 to a ladder, tool box, work bag, and/or any other convenient item when a cover 100 is not in use.

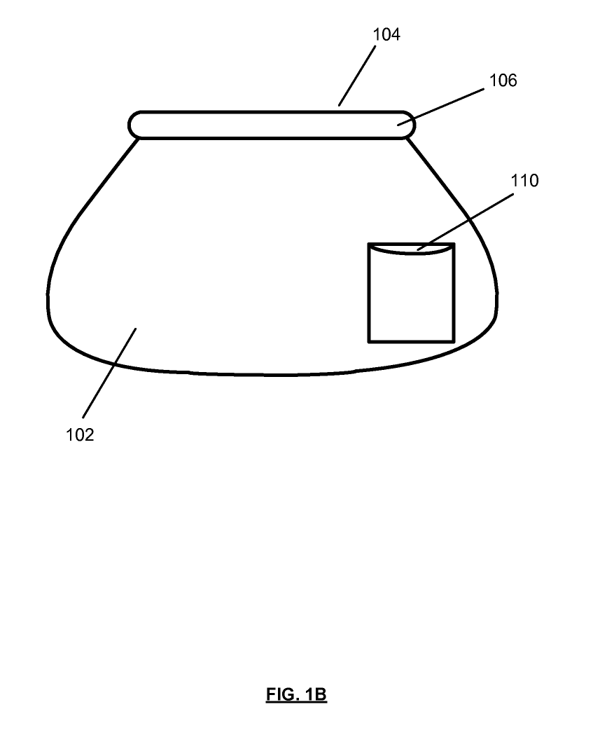

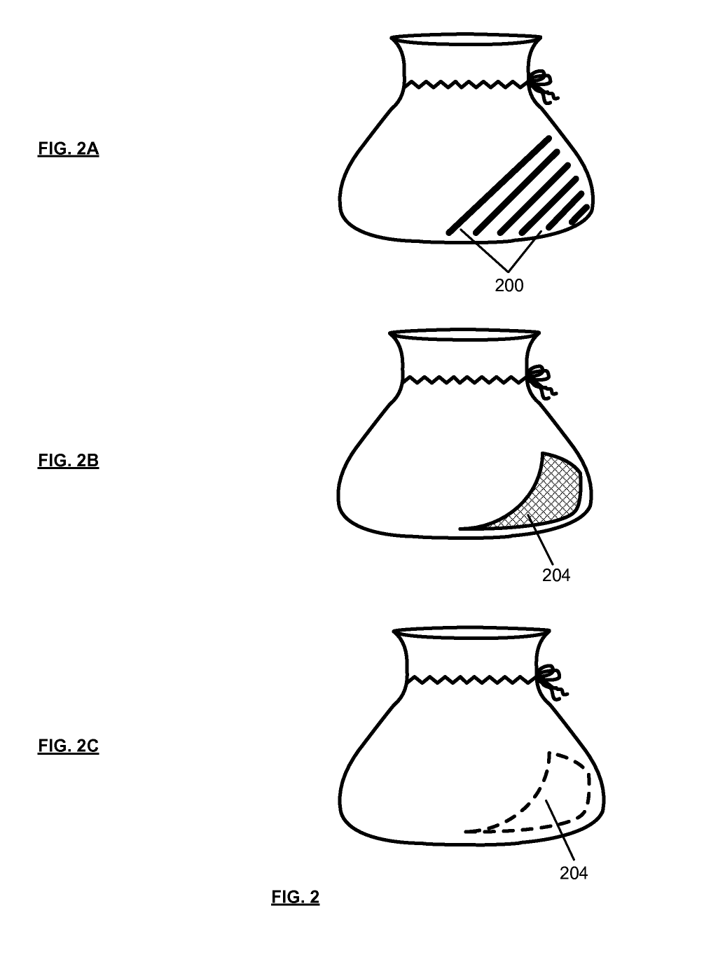

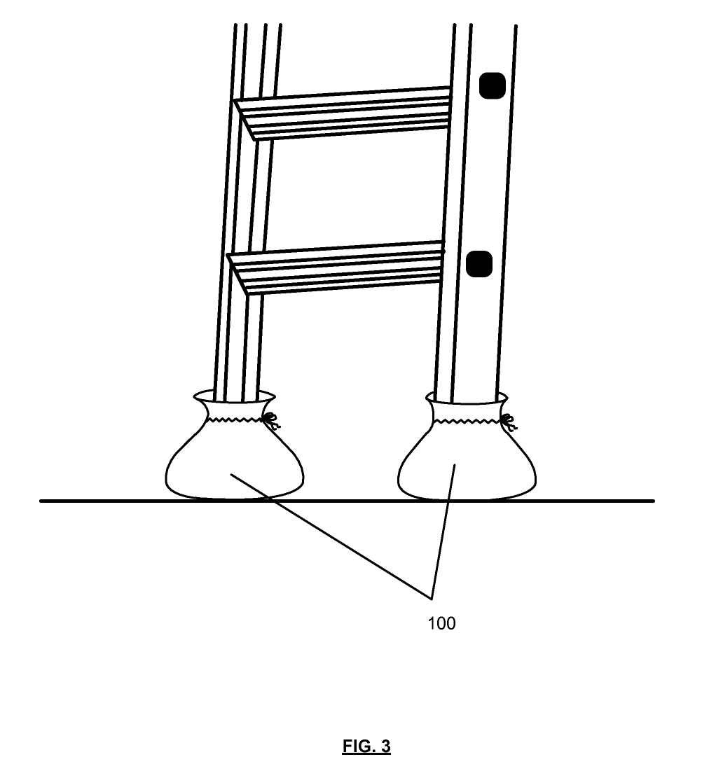

At least one portion of a substantially hollow member 102 can have anti-skid properties, either inherent in the material of a substantially hollow member 102 and/or as a coating 200 on the exterior and/or interior of a substantially hollow member 102, as shown in FIG. 2A. In some embodiments, the material of a substantially hollow member 102 can be substantially thick in order to provide adequate padding when in use. A substantially hollow member 102 can be reusable or can be disposable after one use. In some embodiments in which a substantially hollow member 102 is reusable, a member 102 can be washable, stain resistant, and/or shrink resistant. In some embodiments, the outer surface of a substantially hollow member 102 can have protrusions, indentations, and/or any other known and/or convenient surface characteristic. In yet other embodiments, at least one portion of a substantially hollow member 102 can have ultraviolet coating to protect the underlying material from the harmful effects of ultraviolet radiation. In some embodiments, a substantially hollow member 102 can have antibacterial, antimicrobial, and/or anti-fungal properties to prevent the growth or proliferation of bacteria, mold, and/or fungi during use and/or when in storage. In yet further embodiments, a substantially hollow member 102 can be made of recycled material and/or can be recyclable, biodegradable, and/or eco-friendly.

A substantially hollow member 102 can further comprise a pad 202 in order to provide cushioning and prevent damage to structures when in use. A pad 202 can be comprised of cotton, foam, gel, polymer, or any other known and/or convenient cushioning material. In some embodiments, a pad 202 can be a sponge, honeycomb foam, and/or any other similar type of material. A pad 202 can be coupled with the exterior of a substantially hollow member 102, as shown in FIG. 2B, via stitching, hooks and loops, adhesive, or any other known and/or convenient method of permanently or temporarily bonding a pad 202 to a substantially hollow member 102. In other embodiments, a pad 202 can be embedded within the material of a substantially hollow member 102, as illustrated in FIG. 2C, or adhered to the interior surface of a substantially hollow member 102. In alternate embodiments, a pad 202 can be coupled with a substantially hollow member 102 in any other known and/or convenient manner.

A substantially hollow member 102 can further comprise at least one adjustment mechanism 106 adapted to selectively secure said substantially hollow member 102 over the end of a ladder leg 108 (as shown in FIGS. 1A, 3, and 4). In some embodiments, an adjustment mechanism 106 can be located proximal to an opening 104, as shown in FIG. 1. In alternate embodiments, an adjustment mechanism 106 can define an opening 104, as illustrated in FIG. 1B. In yet other embodiments, an adjustment mechanism 106 can be located at any known and/or convenient point on a substantially hollow member 102. In some embodiments, an adjustment mechanism 106 can be a drawstring, the ends of which can be pulled and tied together in order to tighten a substantially hollow member 102 around a ladder leg end 108, as shown in FIG. 1A. In other embodiments, an adjustment mechanism 106 can be a snap mechanism, hook and loop mechanism, elastomeric member (such as, but not limited to, a rubber band), or any other known and/or convenient mechanism adapted to selectively secure a substantially hollow member 102 to a ladder leg end 108. In yet other embodiments, an adjustment mechanism 106 may not be necessary, as a cover 100 can be an elastomeric member having dimensions smaller than those of a ladder leg end 108, such that a cover 100 can be stretched over a ladder leg end 108 and can be secured to the leg 108 via frictional engagement of substantially the entire cover 100.

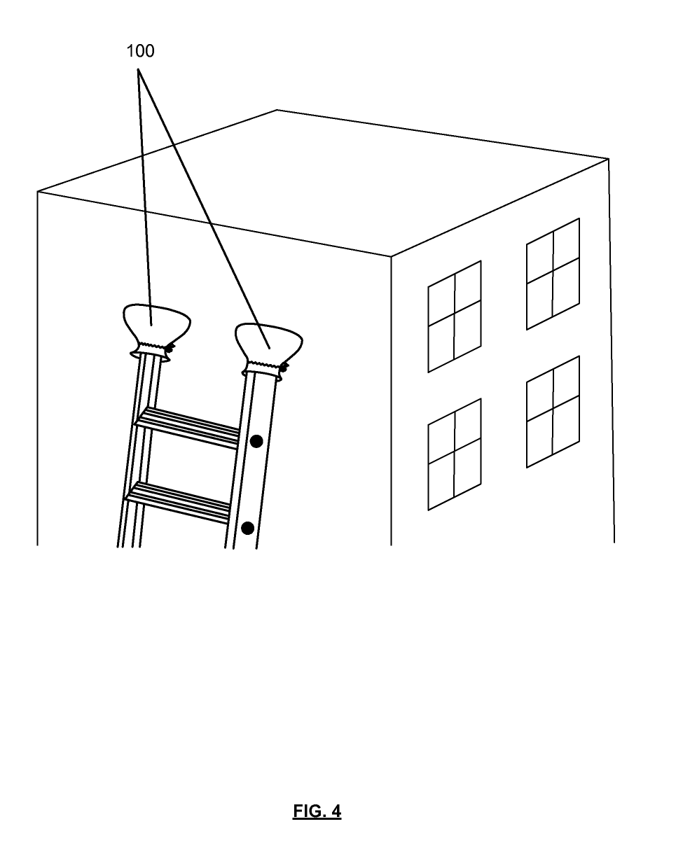

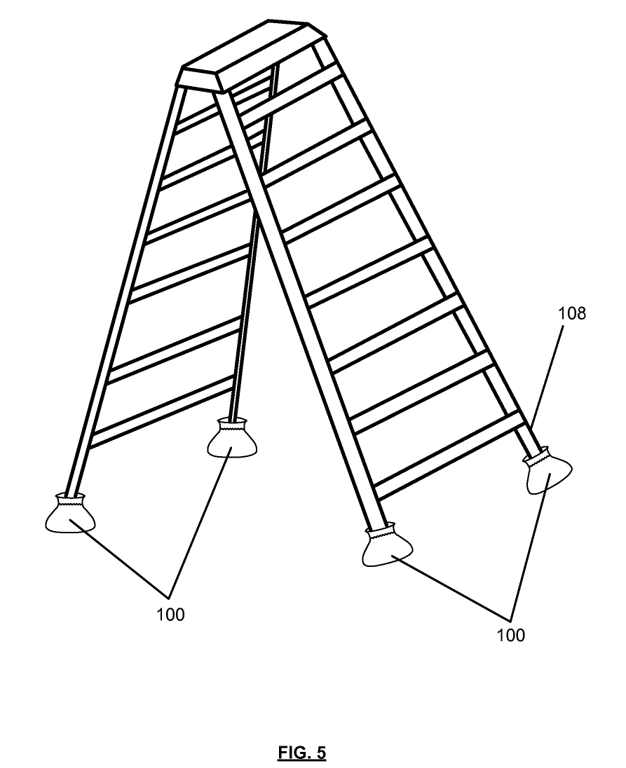

In use, a cover 100 can be placed over the end of a ladder leg 108, as shown in FIG. 1A. Once a cover 100 is in the desired position, a user can temporarily secure the cover 100 to the ladder leg 108 via an adjustment mechanism 106. In the embodiment shown in FIG. 1A, a user can tighten and tie the drawstring so that a cover 100 can be secured over the end of a ladder leg 108. In some embodiments, a cover 100 can be used at the end of a ladder leg 108 which is in contact with the ground, as shown in FIG. 3, thus preventing damage to the ground surface and/or preventing slippage. In other embodiments, a cover 100 can be used at the end of a ladder leg 108 which leans against a wall or other structure, as shown in FIG. 4, thus preventing damage to the structure and/or preventing slippage. Although FIGS. 3-4 depict covers 100 in use with an extension-type ladder, in other embodiments covers 100 can be used in conjunction with the ends of ladder legs 108 on an “A” frame ladder, as shown in FIG. 5.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A protective cover, comprising:
a substantially hollow member having at least one opening;
said at least one opening being adapted to receive the end of a ladder leg;
said substantially hollow member having at least one adjustment mechanism
adapted to hold said substantially hollow member in place when in use.

2. The protective cover of claim 1, wherein said substantially hollow member further comprises at least one anti-skid portion of its outer surface.

3. The protective cover of claim 1, further comprising at least one padded portion coupled with said substantially hollow member.

4. The protective cover of claim 1, wherein said at least one adjustment mechanism is a drawstring.

5. The protective cover of claim 1, wherein said at least one adjustment mechanism is an elastomeric band of material adapted to frictionally engage the end of a ladder leg when in use.

6. The protective cover of claim 1, wherein said substantially hollow member is comprised of at least one material chosen from the group consisting of: plastic, silicone, polymer, cloth, nylon, and reinforced fibers.

7. The protective cover of claim 1, further comprising a coating over at least a portion of a substantially hollow member, said coating being chosen from the group consisting of:
anti-bacterial, ultraviolet, anti-microbial, and anti-fungal.

8. The protective cover of claim 1, further comprising at least one pouch coupled with said substantially hollow member, said pouch being adapted to store said substantially hollow member.

9. A protective cover, comprising:
a substantially hollow member having at least one opening;
said at least one opening being adapted to receive the end of a ladder leg;
said substantially hollow member being made of elastomeric material;
wherein the dimensions of said substantially hollow member are smaller than the end of a ladder leg, such that substantially all of said substantially hollow member can frictionally engage the end of a ladder leg when in use.
